(19) United States
(12) Patent Application Publication
(10) Pub. No.: US 2017/0051813 A1
(43) Pub. Date: Feb. 23, 2017

(54) DEVICE FOR MOVING A FURNITURE PART, AND ITEM OF FURNITURE

(71) Applicant: Grass GmbH, Hoechst (AT)

(72) Inventor: Felix KARU, Altach (AT)

(73) Assignee: Grass GmbH, Hoechst (AT)

(21) Appl. No.: 15/236,770

(22) Filed: Aug. 15, 2016

(30) Foreign Application Priority Data
Aug. 21, 2015 (DE) 20 2015 104 431.3

(51) Int. Cl. F16H 21/44; A47B 88/04; E05F 1/00

(52) U.S. Cl. CPC F16H 21/44; E05F 1/00; A47B 88/0477; E05Y 2900/20

(57) ABSTRACT

A device for moving a movable furniture, the device including a force accumulator received on a mounting part such that by way of a fitted device the movable furniture part under action of the force accumulator is capable of being put in the opening direction of the movable furniture part, and wherein adjustment means for readjusting the force accumulator are present. The adjustment means comprise two mutually separate guide regions which are adapted for guiding an engagement portion on the mounting part, wherein the guide regions are capable of being mutually offset so as to predefine a region in which the engagement portion is received and positioned, wherein the position of the engagement portion is determined by the interaction between the two guide regions such that the position of the engagement portion on the device depends on the mutual relative position of the two guide regions.

This application claims the benefit under 35 USC §119(a)-(d) of German Application No. 20 2015 104 431.3 filed Aug. 21, 2015, the entirety of which is incorporated herein by reference.

### FIELD OF THE INVENTION

The present invention relates to a device for moving a furniture part and an item of furniture.

### BACKGROUND OF THE INVENTION

In the case of furniture parts such as, for example, drawers, furniture doors, or furniture flaps which are movably received on a basic furniture structure of an item of furniture, devices for influencing the movement of the respective furniture part are employed. Devices of this type are formed by a unit which is attachable to the furniture part or to the basic furniture structure at a suitable point, for example.

In the case of modern and user-friendly items of furniture, devices which may optionally be provided for moving the furniture part are known, for example. In particular, the device is fitted on the item of furniture so as to be separate from a sliding guide associated with the furniture part, such as a full pullout or a part pullout, or a pivoting guide, such as a hinge. An additional function for influencing the movement of the furniture part may be provided by way of the device. The additional function may be individually adapted to the type and size of the furniture part, in particular, so as to enable the furniture part to be utilized in a user-friendly manner. This relates, for example, to systems for providing an opening function having force assistance which is adaptable to the furniture part.

### SUMMARY OF THE INVENTION

It is an object of the present invention to advantageously provide an additional function for movement of a furniture part by means of a sliding guide, such as a full pullout or part pullout, or of a pivoting guide, in particular, so as to enable an advantageous force assistance of an opening movement for opening the furniture part on a first partial distance of the opening path.

The present invention proceeds from a device for moving a movable furniture part in an opening direction of the furniture part in relation to a basic furniture structure of an item of furniture, wherein the movable furniture part by way of guide means is capable of being put in the opening direction and in a closing direction which is counter to the opening direction, wherein the device comprises a force accumulator which is received on a mounting part such that by way of the fitted device the movable furniture part under action of the force accumulator is capable of being put in the opening direction of the movable furniture part, and wherein adjustment means for readjusting the force accumulator are present.

Various movement functions relating to moving the furniture part on the item of furniture may advantageously be established by way of the device, in particular, for an opening movement from the retracted or inwardly pivoted position on the basic structure, in that a force of the force accumulator acts in as assisting manner in the case of a movement of the furniture part. In this way, utilization of the furniture part by one person is facilitated, or the required effort in force for the person is reduced, respectively, such that even heavy furniture parts are movable using a comparatively minor personal effort in force, or that even comparatively weak persons such as the elderly or children may open the furniture part. Preferably, the device may be provided so as to be independent of the sliding guide or of the hinge, which are configured, in particular, as a standard guide or as a standard hinge. Guiding of the movement per se in these cases is present so as to be independent of the device according to the present invention having the force accumulator. Accordingly, the device having the force-assisting function is readily retro-fittable and/or replaceable on the item of furniture or on the movable furniture part.

The core concept of the present invention lies in that the adjustment means comprise two mutually separate guide regions which are adapted for guiding an engagement portion on the mounting part, wherein the guide regions are capable of being mutually offset so as to predefine a region in which the engagement portion is received and positioned, wherein the position of the engagement portion is determined by the interaction between the two guide regions such that the position of the engagement portion on the device depends on the mutual relative position of the two guide regions. In this way, adjusting of the force accumulator with a view to a predefinable measure of stored force may advantageously be implemented.

The engagement portion is preferably present on the mounting part such that the engagement portion engages through a clearance, such as an opening, for example, in a component, for example, in a set part, which provides a first guide region. The engagement portion preferably extends in length through the opening in the set part into the second guide region, for example, a guide track, which is not formed by the set part.

Preferably, the force accumulator comprises a force unit having pre-tensioned springs, such as, for example, a spring pack of a plurality of individual springs which in terms of action are mutually complementary. The force unit may comprise a plurality of mechanical springs such as, in particular, coil springs. Each individual spring is received, preferably in a releasable manner, in the force accumulator, the total force action of the force accumulator thus being dependent on the number of springs.

In particular, the force accumulator is rechargeable in an automated manner so as to, following an opening procedure of the furniture part under action of the force accumulator which herein is at least partially discharged, put the force accumulator back to the charged or tensioned initial state thereof, respectively. To this end, the kinetic energy, or the movement of the closing furniture part is used, respectively, for example. For a user, closing of the item of furniture is often possible with less of an effort in force such that the additional effort required for charging the force accumulator is irrelevant. In the case of doors or flaps, the closing movement which is assisted by gravity in the case of the furniture part being closed may optionally contribute toward the discharged force accumulator being recharged.

Opening of the furniture part which in relation to the basic furniture structure is positioned so as to be closed is activated by way of a Tipmatic or of a touch/latch function, for example. Activating the opening movement of the closed static furniture part is performed by external action on the movable furniture part by a user. Herein, the user presses on the furniture part, by way of which the latter is moved by a minor distance in the closing direction, thus performing an activation procedure. The previously retained or locked closing position, respectively, of the movable furniture part is cancelled by the activation procedure. Thereafter, the user leaves the furniture part alone such that the furniture part, while the movement direction is reversed, is automatically moved out of the closing position, this being performed with the aid of the charged force accumulator by way of an opening element, for example. Herein, the furniture part in the opening direction is at least moved across a partial distance of the total potential opening distance. Optionally, the user may manually move the furniture part farther in the opening direction.

Moreover, in the case of the device according to the present invention, a closing system is preferably implemented in such a manner that the movable furniture part under the action of another force source on a last partial distance of the closing movement is gently pulled to a position which, in particular, is fully closed. The closing movement of the furniture part may additionally be performed in a damped manner if and when the device or the closing system integrated therein, respectively, comprises a damping device.

The adjustment means serve, in particular, for adjusting the force accumulator, or a spring bias, for example, and thus the effect of the force accumulator on the movable furniture part, in an adapted manner. This is because, depending on the adjustment or the bias of the force accumulator, respectively, a respective or associated force action of the force accumulator is established, respectively. Adjusting is typically performed once for a respective furniture part, having the mounting part of or the set position thereof on the device, respectively. In the case of a spring pack, one end of the spring pack may be coupled to the furniture part so as to interact with the latter, for example. The other end of the force accumulator engages on the mounting part, the set position of the latter thus predefining the bias of the spring pack, for example.

If and when the position of the mounting part is modified by way of the adjustment means, the bias of the spring pack is also modified. This is possible if and when that end of the spring pack that is assigned to the furniture part is retained. Adjusting the mounting part away from the other end of the spring pack necessitates the spring pack to be extended in length and thus to a higher bias in the charged state. Adjusting the mounting part toward the other end of the spring pack necessitates the spring pack to be shortened in length and thus to slighter bias in the charged state of the force accumulator. A higher bias in the initial state means a higher force action of the force accumulator if and when the closing state of the furniture part is released. A comparatively large or a comparatively heavy furniture part, respectively, may thus be opened or ejected, respectively, in the same manner as a comparatively light furniture part. In the case of a comparatively light furniture part, ideally a slight bias of the force accumulator is adjusted, meaning a slighter force action of the force accumulator.

Precise positioning of the engagement portion and thus of the mounting part may be undertaken by way of the two separate guide regions. The engagement portion preferably comprises an engagement element which is positionally fixed on the mounting part and projects therefrom. The engagement element may have various shapes and, in particular, may be elongate, for example, peg-like or pin-like.

One advantageous variant of the present invention is distinguished in that the two guide regions partially overlap in a mutually adjacent manner and establish an overlap region in which the engagement portion is received and positioned. This enables a particularly precise and jolt-free readjustment, or a readjustment movement, respectively, of the engagement portion and thus of the mounting part. The two guide regions which are present in component portions which are mutually aligned preferably in a planar parallel manner, for example, mutually overlap in a region which in terms of size and shape is adapted to the engagement portion, for example. Preferably, the engagement portion in terms of the position thereof is defined without any perceptible allowance for clearance in relation to the two guide regions. By way of the mutually adjacent superimposition of the two mutually separate guide regions, a crossover region results when viewed in the engagement direction of the engagement portion. The engagement portion in the received state is trapped in the mutually superimposed parts of the two guide regions. Herein, the engagement portion by way of a first external portion bears on a guide region, for example, on a peripheral contour, and by way of a second external portion which is present so as to be offset in relation to the first external portion on the engagement portion bears on the other guide region.

Moreover, it is advantageous for one guide region to be positionally fixed. Preferably, precisely one guide region is positionally fixed, and the other guide region is movable or is capable of being put in various readjustment positions, respectively. When viewed per se, the two guide regions each are preferably larger than would be necessary for the engagement portion to engage. By way of the shape or contour, respectively, thereof, the positionally fixed guide region predefines two or a plurality of predefined positions of the engagement portion. These positions may then be established in a repetitive and a positionally precise identical manner such that the respective identical biases of the force accumulator are capable of being established in a corresponding manner. Preferably, a movement path of the mounting part is substantially predefined by way of the positionally fixed guide region. A spring pack which engages on the mounting part may thus be extended in length or be shortened in length along the positionally fixed guide region, for example, and a bias thus be increased or decreased. The positionally fixed guide region is a straight and/or curved guide track, for example, having two or more set or latched positions, respectively, the engagement portion being lockable in each of the positions. Preferably, the force of the force accumulator herein acts such that the engagement portion remains in a force-assisted manner in the latched position. This secures that the engagement portion remains in the latched position.

According to one advantageous configuration of the present invention, precisely one guide region is movable. The other guide region is then on the device in a positionally fixed manner. A comparatively simple design embodiment is thus achieved for variably predefining the relative position of the two guide regions. As compared with two movable guide regions, the construction of precisely one movable guide region requires less effort and is less complex. The other positionally fixed guide region is advantageously associated with a lower effort in construction. For example, the one movable guide region may be implemented by a component which is movable to and fro in a reversible manner, or is movable or displaceable, respectively, in a rotary, pivotable, rotatable and/or linear manner.

Advantageously, the precisely one movable guide region is operable from the outside, in particular, manually movable by one person. To this end, an operating portion which in the fitted state of the device is reachable on the item of furniture may be present on the respective component.

Alternatively, it is possible that the two guide regions each are movable so as to be readjustable in relation to one another.

According to one modification of the present invention, the guide region comprises a guide contour. The guide contour predefines a movement track for the engagement portion in the case of a variation of the mutual relative position of the two guide regions.

The movement track for the engagement portion is typically formed both by portions of a guide contour of the one guide region as well as by portions of a guide contour of the other guide region. The guide contour preferably comprises portions of various shapes. The positionally fixed guide portion is preferably formed by a guide contour having an extent in the longitudinal direction of the force action of the force unit, or of the individual springs, respectively. The elongate guide region additionally comprises lateral bulges for the engagement portion, so as to predefine two or more steps of readjustment.

In particular, a gate-type guide is preferably implemented on one guide region or on both guide regions.

In particular, the guide regions in flat planar component portions comprise clearances or regions without any material, respectively. Accordingly, the two guide regions are preferably formed in each case on a flat planar component portion. Preferably, one component portion is positionally fixed, and the other component portion is pivotable. The two flat component portions may be positioned in a space-saving manner so as to be directly adjacent or so as to be slightly spaced apart beside one another. The mounting part may be provided in such a manner that the engagement portion engages in both guide regions such as to be aligned transversely to the respective plane of the clearances, or projects from one side, for example, into the two clearances, respectively. The planes of the clearances are preferably parallel. The design embodiment of the guide regions as flat parallel component portions thus enables a very space-saving construction. In particular, the mounting part is also positioned so as to be adjacent to one of the two components having the guide regions.

According to one advantageous variant of the present invention, a guide region is designed as a guide depression and/or as a material-free opening. For example, it is of advantage for a first and a second guide region to be formed by a bore-type opening. The second guide region may optional be designed as a groove-type depression. That engagement portion on the mounting part that is present so as to be adjacent to the first guide region by way of one portion reaches completely through the first guide region and by way of a further portion engages in the second guide region. Preferably, the first guide region is movable, and the second guide region is positionally fixed.

The material-free opening of the respective guide region may be configured in a slot-type manner or as an elongate hole, respectively, for example.

Preferably, each guide region has a guide contour, for example, having a guide face or a guide line such as a peripheral contour, along each of which associated portions of the engagement portion move in a guided manner in the case of a relative movement of the two guide regions, or in the case of the mounting part being readjusted, respectively.

The guide contour may be a peripheral contour, a step contour, a guide face, and/or a guide depression, for example.

Accordingly, the guide contour on the guide region, that is to say that region that in the case of a relative movement of the guide regions comes into contact with the engagement portion by way of the engagement portion engaging in the respective guide region, is configurable in various ways.

For example, the guide contour across the extent thereof is continuous or interrupted, respectively, or is formed by two or more interrupted part-portions.

It is also of advantage for a guide region to be configured on a set part which is present so as to be movable on the device, in particular, on a pivot part which is present so as to be pivotable on the device.

The set part is preferably configured having a lever function, for example, as a lever element. For example, the set part is mounted so as to be displaceable, or having a sliding mounting, or preferably being mounted by way of a pivot mounting. The set part may be received on the device in an advantageously space-saving manner as a flat sheet-metal or plastics part. A pivot mounting moreover enables simple operation by one person in that, for example, an operating portion for manually pivoting the pivot part to and fro is designed on the pivot part. The mutual relative movement of the guide regions is implemented by way of pivoting.

In particular, the guide region on the pivot part has contact portions which come into contact with the engagement portion so as to predefine the position of the engagement portion or of the mounting part, respectively.

The contact portions may comprise a curved border of an opening in the pivot part, the engagement portion engaging through the opening, and moreover further portions, for example, portions of a step which is present so as to be elevated in relation to a flat portion of the pivot part. Preferably, the opening having a first portion of the guide region is configured in the flat part, and a second portion of the guide region is configured on the step. Preferably, the first portion, when in contact with the engagement portion, serves for tensioning or for increasing a bias of the force accumulator, respectively, and the second portion serves for releasing or decreasing the bias of the force accumulator, respectively. This means the first portion in one pivoting direction comes to bear on the engagement portion in a leading manner, and the second portion comes to bear in the other pivoting direction. By way of the respective portion bearing thereon, a force or a momentum, respectively acts on the engagement portion and thus on the mounting part such that readjusting is possible. Accordingly, the force required therefor, in particular, for increasing the bias, is applied by the person who operates the set part.

It is also advantageous for the guide regions to be mutually adapted in such a manner so as to undertake readjusting of the mounting part in multiple steps. In particular, two or more dissimilar effective states of the force accumulator may thus be predefined. The force accumulator is advantageously universally utilizable for various furniture parts. This is performed by readjusting the mounting part. The various readjustment states differ from one another in the force action of the force accumulator on the movable furniture part. The predefinition of the respective predefined steps of readjustment is, in particularly, determined by experience values or by the potential variations in terms of size and/or configuration of the movable furniture part, respectively. In the case of comparatively large furniture parts, or in the case of the use of materials of a comparatively high weight for the movable furniture part, the bias of the force accumulator is increased in that the mounting part is readjusted in a corresponding manner. If and when the force accumulator has a spring pack having force springs, the force springs are extended in length or are more highly tensioned, respectively, for example. To this end, the mounting part is readjusted from a preadjusted basic position to a first readjustment step, for example.

The readjustment steps may be secured by a locking mechanism or a latching mechanism, respectively.

Alternatively, however, stepless readjusting of the mounting part is also capable of being established. In this way, the bias of the force accumulator may also be predefined, or increased or decreased, respectively, in a stepless manner.

According to one advantageous modification of the present invention, a guide region which comprises separate contact portions for contacting the engagement portion on the mounting part is present on a movably mounted component. The component is, in particular, the set part or the pivot part, respectively. The contact portions may have a narrow periphery of an opening or of a bore, respectively, in the set part, along which opening or bore, respectively, the engagement portion is readjustable in a guided manner when the set part is moved. A further contact portion, separate therefrom, on the set part may have a contour on an elevation or on a step.

It is further of advantage that a guide region is present on a movably mounted component, wherein a first contact portion for contacting the engagement portion on the mounting part is configured for increasing a bias of the force accumulator, and a second contact portion for contacting the engagement portion on the mounting part is configured for decreasing the bias of the force accumulator. This is advantageous with a view to a compact assembly having little wear. In particular, as compared with the other contact portion, the first contact portion may lie in another plane on the movably mounted component.

One advantageous configuration of the present invention is characterized in that the mounting part on the device by way of the engagement portion is readjustable in a guided manner, wherein the mounting part is guided on the device by way of an auxiliary guide having an auxiliary engagement portion. The auxiliary guide serves for improved or additional guiding, respectively, in the case of the force accumulator being readjusted. Jolt-free readjusting is thus achieved. For example, the auxiliary guide further to the engagement portion comprises a further portion which projects from the mounting part, for example, and engages in a matching auxiliary guide track and therein is movable to and fro in a laterally guided manner, for example, when the mounting part is being readjusted.

It is also of advantage that the adjustment means are adapted in such a manner that a self-securing readjustment position of the mounting part is established on the device under the action of the force accumulator. An adjusted readjustment position is thus securely maintained for so long until intentional readjusting of the mounting part is performed.

The present invention moreover relates to an item of furniture having a basic furniture structure on which a furniture part by way of guide means for a guided movement is movable in an opening direction and in a closing direction which is counter to the opening direction, wherein the guide means comprise a device according to one of the configurations as have been explained above.

The mentioned advantages are thus achieved on the item of furniture, in particular, on an item of furniture having a drawer or an upper flap or a pivot door. The device is preferably implemented as a flat fitting component which is attached to a lower side of a drawer base, for example, wherein an opening element of the fitting, which is impinged upon by the force accumulator and is capable of being offset, impacts like an ejector on a counter portion in the case of an opening procedure. The force accumulator assists the opening movement of the opening element in the case of the opening procedure of the latter. For example, the biased spring pack acts on the opening element in the offset movement thereof in such a manner that the opening element impacts on the counter portion, the drawer in the opening direction thereof thus being moved out of the closed position on the basic furniture structure.

### BRIEF DESCRIPTION OF THE DRAWINGS

Further features and advantages of the present invention are explained in more detail by means of exemplary embodiments which are schematically illustrated in the figures.

FIG. 1 shows an item of furniture according to the present invention in a perspective view from obliquely above, having a drawer in a completely opened state on a basic furniture structure;

FIG. 2 shows a device according to the present invention, without a cover component, in a exploded illustration;

FIGS. 3 to 8 show the device according to FIG. 2, in an assembled state, in a plan view of a first main side, in various operational states;

FIG. 9 shows the device according to FIG. 5, having the cover component, in a perspective view from obliquely below toward a second main side of the device;

FIG. 10 shows a fragment of the base plate having two guide tracks;

FIG. 11 shows a set part in a plan view, which is disposed in the region of the fragment of the base plate that is shown in FIG. 8;

FIG. 12 shows a mounting part of a force accumulator; and

FIGS. 13 to 22 schematically show a fragment of the ejector unit in a plan view, having the two guide tracks, the set part, and the mounting part, in various readjustment positions.

### DETAILED DESCRIPTION OF THE INVENTION

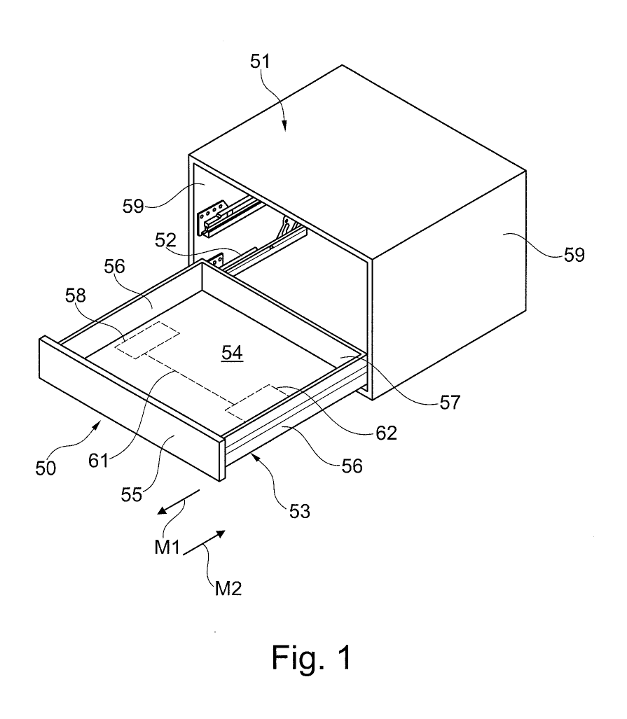

An item of furniture 50 according to the present invention, having a box-shaped basic furniture structure 51 and a drawer 53 which by way of guide means 52 is movably guided, is illustrated in FIG. 1. The drawer 53 comprises a drawer base 54, a drawer front 55, side walls 56, and a rear drawer wall 57. Two guide means 52 with identical action for guiding the drawer 53 are present in each case between each side wall 56 of the drawer 53 and an associated basic-structure side wall 59. A device 58 according to the present invention (illustrated with dashed lines), for moving or ejecting, respectively, the furniture part which is configured as a drawer 53 in the opening direction M1 is disposed on a lower side of the drawer base 54.

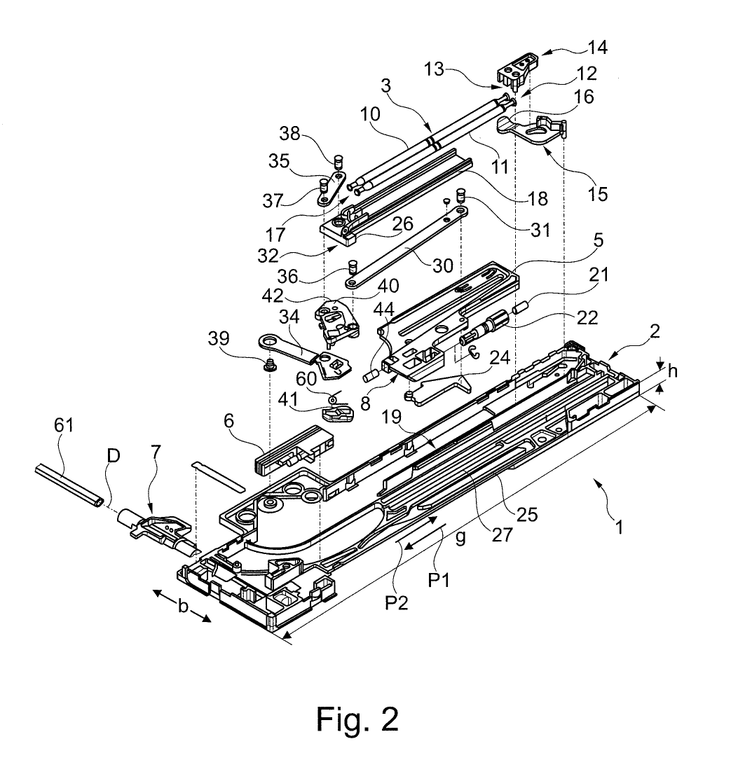

FIG. 2 shows the exploded illustration of the device 58 which is configured as an ejector unit 1 for the drawer 53.

The ejector unit 1 serves for the force-assisted ejection of the drawer 53 across a first part-distance of the opening movement of the drawer 53 in relation to the basic furniture structure 51, from a closed position in the opening direction M1 of the drawer 53.

The drawer 53 by way of the guide means 52, for example, two identical part-pullout units or full-pullout units, is mounted on the basic furniture structure 51 so as to be displaceable in the directions M1 and M2. Alternatively, the ejector unit 1 may be disposed on the basic furniture structure 51 or on the guide means 52 of the item of furniture 50.

The ejector unit 1 comprises inter alia a base plate 2, a force accumulator 3, a coupling installation 4, an ejector 5, an activator 6, and a locking member 7.

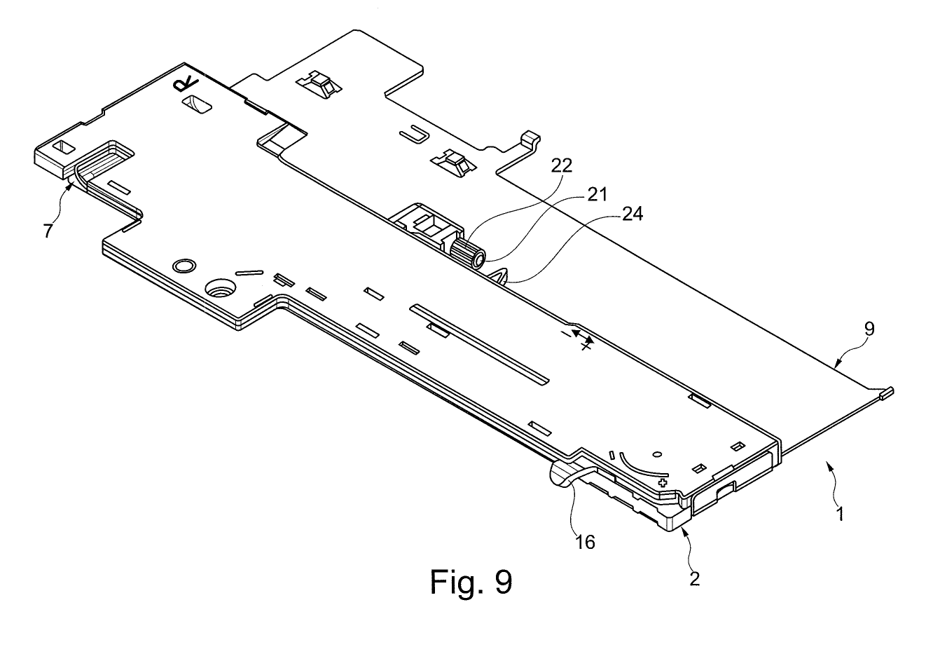

A housing of the ejector unit 1 comprises the base plate 2 and a cover component 9 which is visible in FIG. 9. The ejector unit 1 may be disposed on the lower side of the drawer base 54 and/or on the guide means 52 by way of the housing or by way of the cover component 9 and/or the base plate 2, respectively.

Retaining portions, guide contours, stop members, and/or receptacle portions for linking the individual components of the ejector unit 1 are configured on the base plate 2. The base plate 2 is designed substantially as a rectangular, elongate or strip-shaped component, having a comparatively minor height h of approx. 5 to 15 millimeters, for example. The base plate 2 furthermore has a width b of approx. 4 to 10 centimeters, and a length g.

According to the exemplary embodiment shown, the force accumulator 3 comprises two identical coil springs 10, 11 which configure a spring pack and which are disposed in parallel. At a first end 12 of the force accumulator 3, the coil springs 10, 11 are disposed on an adjustable fixed mounting 13. The fixed mounting 13 comprises a movable mounting part 14 on which the coil springs 10, 11 are received in a releasable yet fixed manner, and a set part 15 having an operating portion 16 by way of which a user may adjust from the outside a position of the end 12 of the force accumulator 3 in a modifiable and positionally fixed manner. On account thereof, an effect of force of the force accumulator 3 on the drawer 53 may advantageously be pre-adjusted in the case of the opening procedure of the drawer 53.

The associated ends of the coil springs 10, 11 are fastened to a slide-type motion element 18 at a second end 17 of the force accumulator 3. The slide-type motion element 18 by way of an associated guide contour 19 is linearly guided on the base plate 2 so as to be movable in a movement direction P1 and in an opposite movement direction P2.

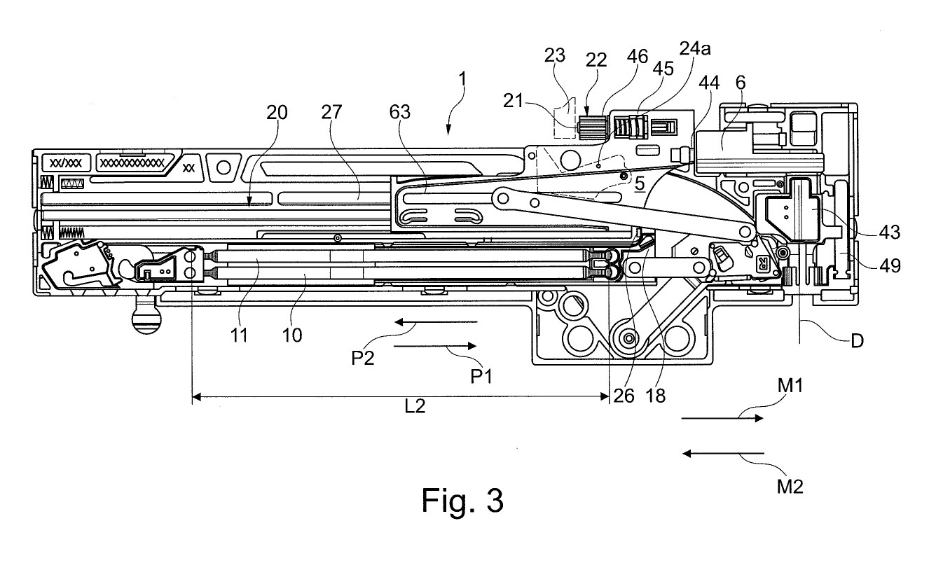

The movement directions P1 and P2 of the motion element 18 (cf. FIGS. 2, 3) run parallel with the opening direction M1 of the drawer 53 and with a closing direction M2 which is counter thereto.

If and when the ejector unit 1 is disposed in a positionally fixed manner on the basic furniture structure 51 and/or on a stationary part of the guide means 52, the opening direction of the drawer 53 corresponds to the direction P1, and the closing direction of the drawer 53 corresponds to the direction P2.

Herebelow, an assembled state of the ejector unit 1 on the drawer base 54 is assumed.

FIGS. 3, 7, 8 show the ejector unit 1 in a tensioned state of the force accumulator 3, in which the coil springs 10, 11 are elongated or are tensioned so as to be under a tensile load, respectively; herein, the motion element 18 in relation to a retracted position in the direction P2 is offset on the base plate 2 in the direction P1 and is retained in a tensioned position.

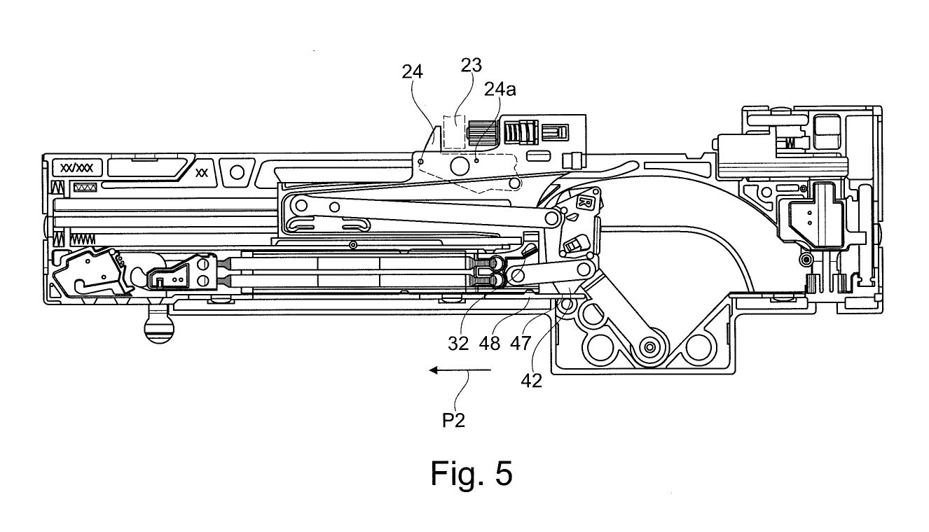

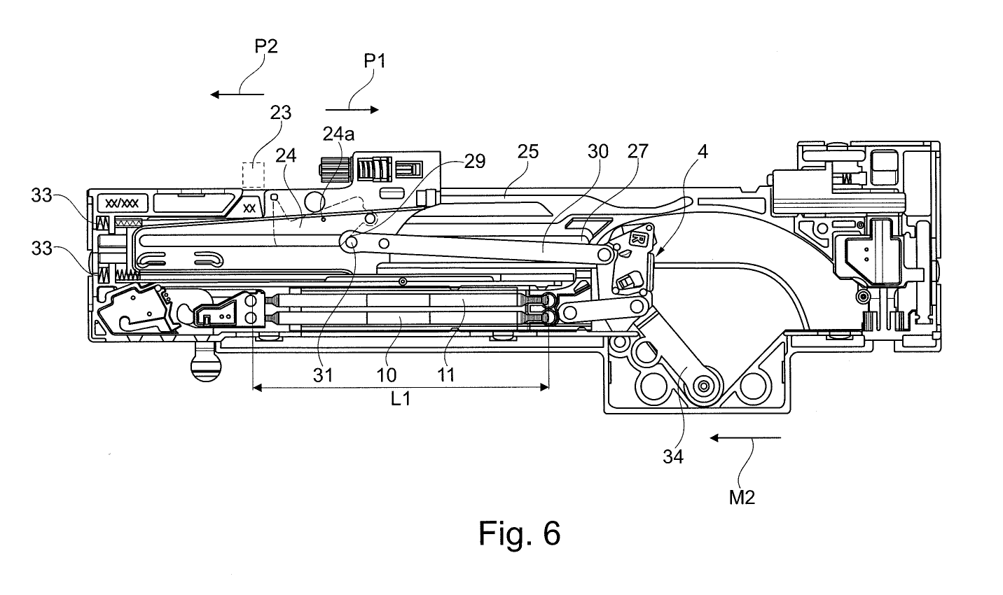

FIGS. 5, 6 show the ejector unit 1 in a discharged basic state of the force accumulator 3, in which the coil springs 10, 11 are furthermore pre-tensioned under a tensile load but to a lesser degree, having a length L1.

In the tensioned state of the force accumulator 3 the coil springs 10, 11 have a length L2 which is greater than L1.

A retaining member 32 having a stop element 26 is present on the motion element 18.

By way of the coupling installation 4, the force accumulator 3 or the motion element 18, respectively, is operationally connected to the ejector 5, preferably exclusively in the case of the closing procedure of the drawer 53. In particular, the ejector 5 is exclusively movable in a linear manner, or movable to and fro so as to be parallel with the movement direction of the motion element 18, respectively, in the directions P1 and P2. To this end, a linear guide 20 which is adapted to guide portions, for example, on one side of the ejector 5 is configured on the base plate 2.

An opening procedure of the drawer 53, caused by the ejector unit 1, takes place exclusively by way of a direct operational connection of the force accumulator 3 to the ejector 5, by way of the motion element 18 which moves in the direction P2. To this end, the stop element 25 which is advantageously designed so as to be elastic and thus prevents or at least dampens any sound which is disturbing to the user when the motion element 18 impacts the ejector 5 in the opening procedure of the drawer 53 is configured on the motion element 18 (FIGS. 3, 4, 5).

A front-gap adjustment assembly 8 which is configured on the ejector 5 comprises a housing 45 and a set screw 22 having a contact portion 21. The set screw 22 has an external thread which interacts with an internal thread on the housing 45. Depending on the rotation direction, a position of the contact portion 21 of the set screw 22 is adjustable in the direction P1 or P2 by manual rotation of an operating portion 46 of the set screw 22 by a user. In particular, the set screw 22 is configured so as to be self-locking in relation to the housing 45. A measure of a front gap between the drawer front 55 of the drawer 53, which is closed on the basic furniture structure 51, and end sides of the basic furniture structure 51 is capable of being predefined by way of the predefined position of the set screw 22.

The contact portion 21 of the set screw 22 in the tensioned or charged state, respectively, of the force accumulator 3 bears on an entrainment element 23 which in respective operational states forms a stop for the contact portion 21. The entrainment element 23 which in FIGS. 3 to 8 is merely indicated by dashed lines may be present on a fixed rail of the guide means 52, for example, or be attached to the basic furniture structure 51 when the ejector unit 1 is disposed on the drawer 53.

However, if and when the ejector unit 1 is disposed on the basic furniture structure 51 or on a positionally fixed part of the guide means 52 of the item of furniture 50, the entrainment element 23 may be present on the drawer 53 and thus be movable in relation to the basic furniture structure 51.

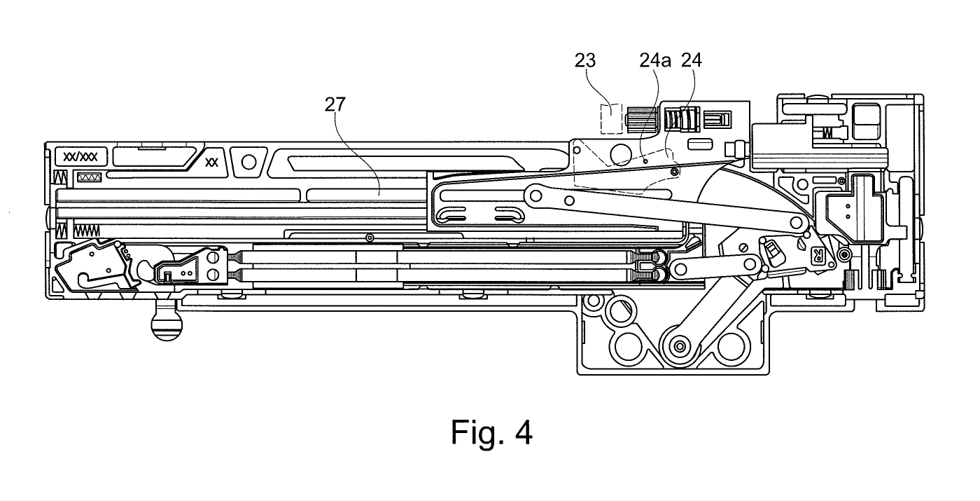

If and when, proceeding from the basic position of the ejector unit 1 according to FIG. 3, a locking feature is cancelled on the ejector unit 1, as is shown in FIG. 4 and will be explained in more detail below, the tensioned or charged force accumulator 3, respectively, pulls the motion element 18 in the direction P2, the latter by way of the stop element 26 urging or sliding, respectively, the ejector 5 in relation to the base plate 2 in the direction P2.

As soon as the ejector 5 on the base plate 2 moves in the direction P2, a latch component 24 of the ejector unit 1, which is pivotably mounted on the ejector 5, is put from an inwardly pivoted position according to FIG. 4, in which the latch component 24 in relation to an external periphery of the base plate 2 is completely retracted, to an outwardly pivoted position in which the latch component 24 by way of a cam partially projects beyond the external periphery of the base plate 2 (FIG. 5), this being implemented by way of a loop-shaped closed guide track 25 in the base plate 2 and by way of a guide pin 24a, engaging in the guide track 25, on the latch component 24.

In order for the latch component 24 to be illustrated, the outline thereof which is obscured by other components, in particular, by the ejector 5, in FIGS. 3 to 8 is indicated with dashed lines.

In the basic state which is illustrated in FIG. 5, the force accumulator 3 is located in a terminal position of the discharged state, wherein the force accumulator 3 is unable to move the ejector 5 any farther in the direction P2.

By virtue of the kinetic energy of the drawer 53, caused by the preceding ejection movement and/or by manually moving the drawer 53 farther in the opening direction M1 by a user, the ejector 5 is subsequently displaced in relation to the base plate 2 in the direction P2. This is possible because the latch component 24 which has been outwardly pivoted so as to project from the ejector 5 bears on the entrainment element 23, the ejector 5 in the further course of the movement of the drawer thus reaching the terminal position thereof which is displaced to a maximum in the direction P2 on the base plate 2. By reaching the terminal position on the ejector 5, the latch component 24 is again completely pivoted inwardly, this being predefined by the interaction between the guide track 25 and the guide pin 24a on the latch component 24 being engaged therein.

If and when the drawer 53 following a discharging procedure of the force accumulator 3 is moved farther in the opening direction M1, the ejector unit 1 separates from the entrainment element 23, cancelling contact between the entrainment element 23 and the contact portion 21 of the set screw 22 (FIG. 6).

From the terminal position described above, which the ejector assumes only briefly, the ejector 5 by spring elements 33 on the base plate 2 is urged by a few millimeters in the direction P1, for example. In relation to the coil springs 10, 11 of the force accumulator 3, the spring elements 33 have a comparatively minor force. By way of the movement of the ejector 5 in the direction P1 by way of the force of the spring element 33, a bearing portion 29 of the latch component 24 in a standby position of the ejector 5 is put in direct clearance-free contact with a mounting pin 31 of a tension lever 30 of the coupling installation 4 (FIG. 6). The mounting pin 21 is disposed on a first end of the tension lever 30 and may move freely along a, for example, linear, guide track 27 and/or a linear guide 63 which is configured on the ejector 5 for so long, and, in particular, within an opening procedure of the drawer 53, until the latch component 24 holds the mounting pin 31 and/or the tension lever 30 in direct, clearance-free contact with the ejector 5.

The standby position of the ejector 5 which is shown in FIG. 6 at the same time is also a starting position of the ejector 5 for a charging procedure of the force accumulator 3 by way of the coupling installation 4.

Besides the tension lever 30, the coupling installation 4 comprises a guide lever 34 and a connection element 35. By way of a mounting pin 36, the tension lever 30 on a second end is articulated on the guide lever 34. The connection element 35, on a second end, by way of a mounting pin 37 which is spaced apart from the mounting pin 36, is likewise articulated on the guide lever 34, and on the first end thereof, the connection element 35 by way of a further mounting pin 38 is articulated on the motion element 18. The guide lever 34 at a first end by way of a mounting pin 39 is disposed so as to be movable, in particular, pivotable, on the base plate 2. The mounting pin 39 is preferably received both on the base plate 2 as well as on the cover component 9.

A longitudinal axis A1 of the tension lever 30, which runs through the mounting pins 31, 36 of the tension lever 30, in relation to a first longitudinal axis A2 of the guide lever 34, which runs through the mounting pins 36, 39, has an angle α.

A longitudinal axis A3 of the connection element 35, which runs through the mounting pins 37, 38 of the connection element 35, in relation to a second longitudinal axis A4 of the guide lever 34, which runs through the mounting pins 37, 39, has an angle 3.

The guide lever 34 of the coupling installation 4, on a second end, comprises a lever attachment 40. A locking element 41 and a stop element 42 are configured on the lever attachment 40.

The terminal position of the discharged state of the force accumulator 3 (FIG. 5) is predefined by a stop of the stop element 42 of the guide lever 34 on a wall portion 47 on a step-type wall 48 of the base plate 2. The wall portion 47 is formed from an annular portion of a damping element, for example. If and when the stop element 42 of the guide lever 34 following a discharging procedure of the force accumulator 3 bears on the wall portion 47, by virtue of a remaining bias of the coil springs 10, 11 a tensile force in the direction P2 is transmitted from the motion element 18 by way of the connection element 35 to the guide lever 34. By virtue of the rigid embodiment of the coupling installation 4, or by virtue of the impact of the stop element 42 on the wall portion 47, respectively, the motion element 18 is prevented from moving farther in the direction P2, wherein the force accumulator 3 by way of the motion element 18 is held free of clearance in the terminal position of the discharged position.

In particular, the stop element 42 and/or the wall portion 47 may be designed so as to be elastic or damping, respectively, thus reducing or preventing an impact noise.

When tensioning the force accumulator 3, the guide lever 34 by virtue of the design thereof may transmit a force from the tension lever 30 to the connection element 35 at a geared ratio.

The gear ratio is formed, on the one hand, by the ratio of the spacing of the mounting pins 39 and 36 in relation to the spacing of the mounting pins 39 and 37 on the guide lever 34 and, on the other hand, by the combined mutual circular and linear movement of the tension lever 30 and/or of the connection element 35 during the charging procedure of the force accumulator 4.

The elements of the coupling installation 4, by virtue of the arrangement of the former on the ejector unit 1, may move as follows:

The mounting pin 31 and thus the first end of the tension lever 30, by virtue of the mounting thereof in the guide track 27, may move exclusively parallel with a movement direction of the ejector 5, in particular, parallel with a movement direction of the movable furniture part 53.

The mounting pin 38 and thus the first end of the connection element 35, by virtue of the mounting thereof on the slide-type motion element 18 and thus advantageously in the guide contour 19, may move exclusively parallel with a movement direction of the motion element 18 or of the ejector 5, respectively, in particular, parallel with the movement direction of the movable furniture part 53.

The mounting pin 36 and thus the second end of the tension lever 30, by virtue of the mounting thereof at the second end of the guide lever 34, may move exclusively in a circular path about a rotation center of the mounting pin 39 of the guide lever 34.

The mounting pin 37 of the connection element 35 and thus the second end of the connection element 35, by virtue of the mounting thereof in a central region of the guide lever 34, may move exclusively in a circular path about a rotation center of the mounting pin 39 of the guide lever 34.

By virtue of the above-mentioned design, the coupling installation 4 may advantageously transmit at a different gear ratio a force for tensioning the force accumulator 3 from the ejector 5 by way of the tension lever 30 and of the guide lever 34 to the connection element 35 and thus to the force accumulator 3, and, in particular, the coupling installation 4 transmits the force which is exerted by the ejector 5 in a geared-down ratio to the force accumulator 3. This means that a user when charging the force accumulator 3 has to apply less force to the ejector 5 than the user would have to apply when wishing to charge the force accumulator 3 without gearing-down, or when directly pulling the end 17 of the force accumulator 3 in the direction P1, respectively.

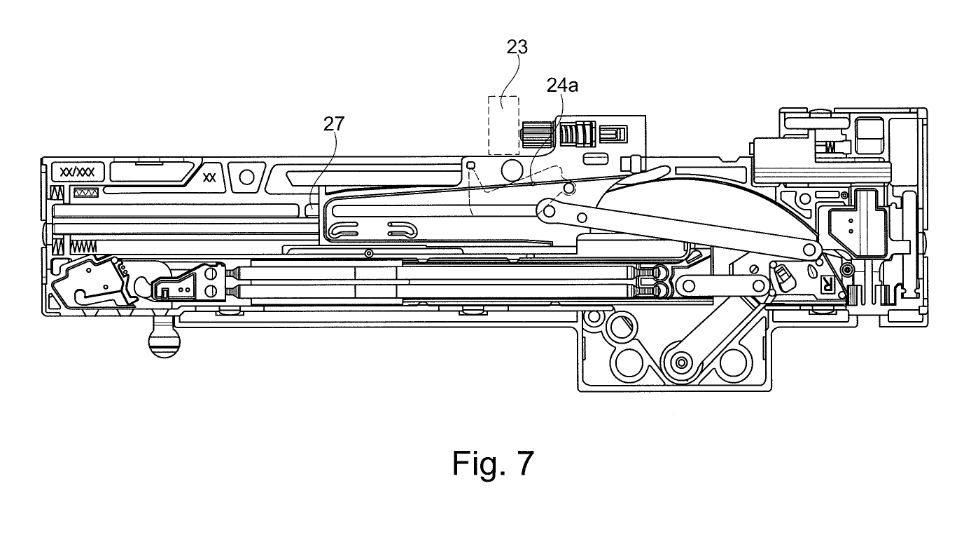

The beginning and the end of the charging procedure of the force accumulator 3 or of the coil springs 10, 11, respectively, is visualized in FIGS. 6 and 7.

Tensioning of the force accumulator 3 is performed by a movement of the drawer 53 in the case of closing, or on a part-distance of the closing movement of the drawer 53. The starting position of the ejector unit 1, in which the latter is prepared for tensioning of the force accumulator 3 and expects a closing procedure of the drawer, is shown in FIG. 6.

If and when the drawer 53 is closed, for example, from the outside by a user, the ejector unit 1 moves in the direction M2 toward the entrainment element 23. The charging procedure of the force accumulator 3 begins as the contact portion 21 of the set screw 22 of the ejector 5 impacts on the entrainment element 23. The ejector 5, by impacting on the entrainment element 23, is moved in the direction P1, for example, by virtue of the inertia of the drawer 53 in relation to the base plate 2.

By way of the coupling of the ejector 5 to the force accumulator 3 by way of the coupling installation 4, the motion element 18 of the force accumulator 3 is likewise displaced in relation to the base plate 2 in the direction P1, and the second end 17 of the coil springs 10, 11 is displaced in the direction P1, the coil springs 10, 11 thus being elongated.

At the end of the tensioning procedure of the force accumulator 3, the ejector 5 is located in a terminal charging position, as is shown in FIG. 7. In a tensioned state of the force accumulator 3, the ejector unit 1 is located in a locked state.

In the locked state, a locking state is determined by the locking element 41 of the coupling installation 4 and by the locking member 7 which is configured as a flap, wherein a discharging movement of the coupling installation 4 is blocked by the locking member 7.

Tensioning of the force accumulator 3 is fully completed prior to an automatic retracting feature for the force-assisted retraction of the drawer 53 to the fully closed position on the basic furniture structure 51 becoming effective, for example. The automatic retracting feature is not part of the ejector unit 1, and is integrated in the guide means 52 or in the part-pullouts or full-pullouts, respectively, for example.

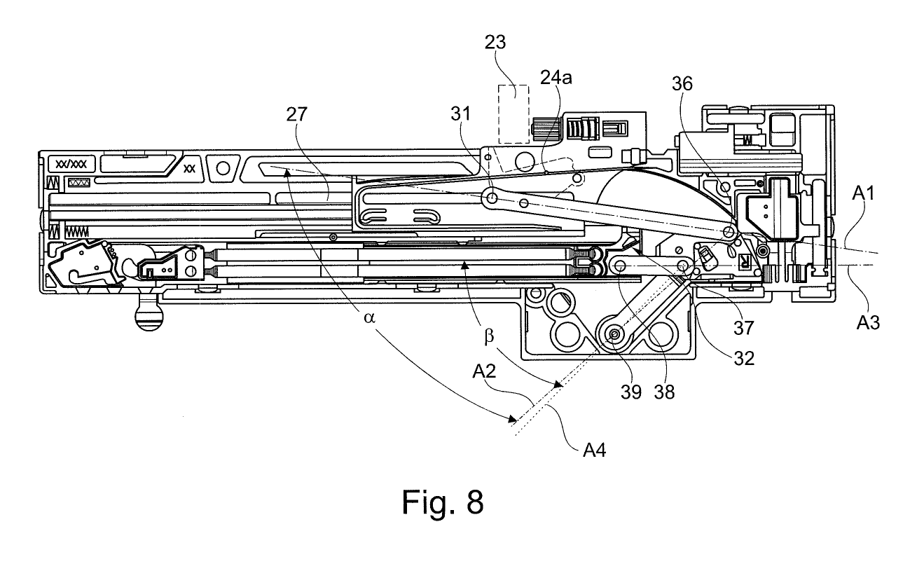

After the force accumulator 3 has been tensioned, the ejector 5 by virtue of bearing on the entrainment element 23 is moved farther in relation to the base plate 2 by way of the further closing movement of the drawer 23. Herein, the operational connection between the latch component 24 of the ejector 5 and the mounting pin 31 of the tension lever 30 is cancelled. This is performed by an interaction between the guide track 25 and the guide pin 24a on the latch component 24, wherein the latch component 24 by the guiding of the guide pin 24a in the guide track 25 is pivoted away from the mounting pin 31 (FIG. 8). In this state, the ejector 5 is uncoupled from the coupling installation 4 and is displaceable so far in the direction P1, in particular, by an automatic retracting feature, until the drawer 52 is fully closed on the basic furniture structure 51, and the ejector 5 bears on the activator 6 in the basic position according to FIG. 3.

In the basic position of the ejector unit 1 according to FIG. 3, it is possible for a user to pull the drawer 53 in the opening direction M1 without an ejector function or without first manually cancelling the locking state, respectively. Herein, the force accumulator 3 of the ejector unit 1 is non-actuated or charged, respectively.

In order for the drawer 35 by way of the ejector unit 1 to be expelled from the position in which the drawer 35 is completely retracted or closed, respectively on the basic furniture structure 51, a user has to act on the drawer while pushing from the outside in the direction M2. To this end, the ejector unit 1 has a so-called touch-latch function which knows a locked state which is unlockable in that the retracted drawer 53 which is closed on the basic furniture structure 51 is moved in the closing direction M2. This closing movement, or inwardly pushing of the drawer 53 in the direction M2, respectively, is performed until a stop position corresponding to a front gap which in the closed state of the drawer 53, is predefined, in particular, by way of a spacing between an internal side of the drawer front 55 and a forward end side or the side walls 56 of the basic furniture structure 51, respectively, is reached. The front gap is typically a few millimeters, for example, approx. 1 to 10 millimeters.

Accordingly, unlocking of the ejector unit 1 is adapted in such a manner that a closing movement of the drawer 53 in the direction M2 of a few millimeters, or at maximum by the value of the front gap, respectively, is sufficient for unlocking and thus the force-assisted ejection of the drawer 53 to be reliably predefined.

Proceeding from the basic position according to FIG. 3, the ejector unit 1 together with the drawer 53 is moved in the direction M2. Since the set screw 22 bears on the entrainment element 23, the ejector 5 is moved in relation to the base plate 2 in the direction P1, a contact portion 44 on the ejector 5 thus pressing against the activator 6, accordingly pushing the latter in the direction P1. The activator 6 is present on the base plate 2 so as to be linearly displaceable in a limited manner, typically by a few millimeters or by less than the dimension of the front gap, respectively, in the directions P1 and P2.

The activator 6 is preferably directly coupled to the locking member 7 which is designed as a flap 43 in such a manner that the linear activation movement of the activator 6 in the direction P1 sets the flap 43 in rotary motion about a pivot axis D. The flap 43 by the rotating movement is released from a locked position into which the flap 43 is urged by a spring member which is configured as a leaf spring 49. In the locked state of the ejector unit 1, the flap 43 which is located in the locking position blocks the guide lever 34 or the lever attachment 40, respectively, in such a manner that the force accumulator 3 remains in the charged state thereof.

Blocking of the guide lever 34 is cancelled by the rotating movement of the flap 43. The locking element 41 on the lever attachment 41, which is biased by a leg spring 60, hereby preferably pivots out.

The locking element 41, which projects from the lever attachment 40, moves conjointly with the pivoting procedure of the guide lever 34 below the flap 43, past the latter, and continues without interruption the rotating movement of the flap 43, initiated by the activator 6, about the pivot axis D. On account thereof, a rotation angle of the flap 43 out of the locking position is advantageously enlarged. The ejector unit 1 is reliably unlocked by the movement of the lever attachment 40 below and past the flap 43 and continued by the outwardly pivoting locking element 41. To this end, advantageously a comparatively very minor linear activation movement of the activator 6 in the direction 91 is required. Subsequently, the flap 43 by the leaf spring 49 is urged back into the locking position of the former.

The locking element 41 which is present so as to be outwardly pivoted on the lever attachment 40 is again brought to bear on a front edge of the flap 43 when the force accumulator 3 is tensioned. Herein, the locking element 41, yields counter to the spring force of the leg spring 60, such that the locking element 41 is retracted so far on a periphery of the lever attachment 40 that the guide lever 34 by way of the lever attachment 40 can pivot past the flap 43.

Behind the flap 43, the locking element 41 is outwardly pivoted again by the spring force of the leg spring 60. Following the tensioning procedure, the guide lever 34 by way of the projecting locking element 41 is pushed against the flap 43 which is held by the leaf spring 49 so as to lock, the force accumulator 3 thus being in the locked state.

The rotating movement of the flap 43 of the ejector unit 1, or of the device 58, respectively, is transmitted by a synchronizer bar 61 which is disposed so as to be rotationally fixed on the flap 43 to a second device 62 which is advantageously of identical action and which is disposed on the drawer 53.

The synchronizer bar 61 advantageously connects the locking member 7 to a second locking member which is present on the second device 62. The two locking members are thus directly and/or synchronously coupled in terms of motion. This represents a synchronizing principle which is contrary to a connection between activator elements of two ejector units on one furniture part.

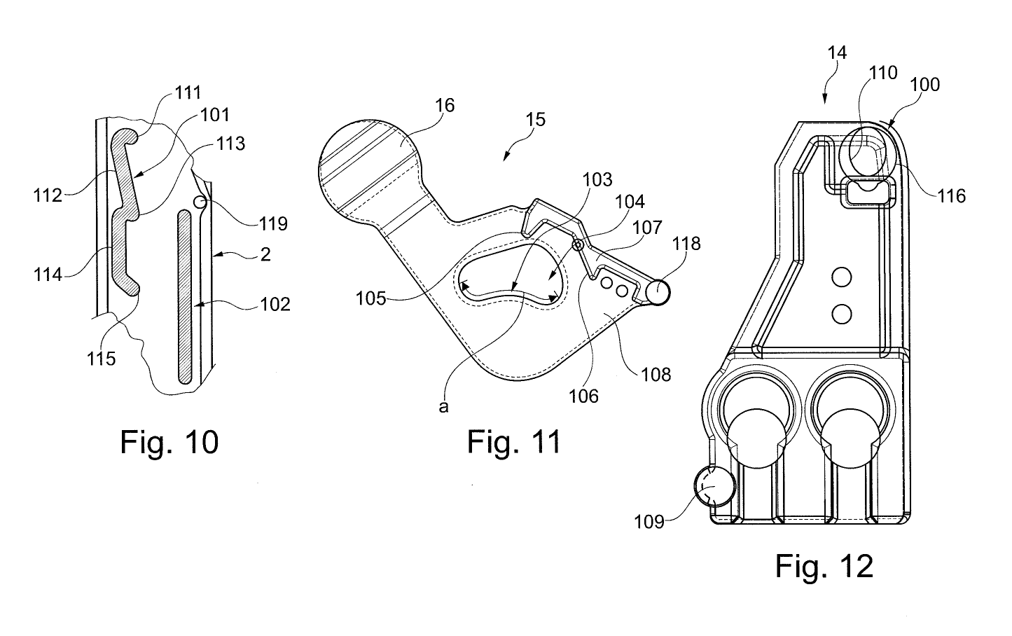

FIG. 10 shows a fragment in a region of the base plate 2 which is located in the longitudinal extension of the force accumulator 3 and in which the fixed mounting 13 of the force accumulator 3 is present. Two separate gate-type guides comprising a guide track 101 and a slotted track 102 are configured in the base plate 2. The guide track 101 together with the set part 15 according to FIG. 11, and with the mounting part 14 according to FIG. 12, serves as an adjustment means for readjusting a bias of the force accumulator 3.

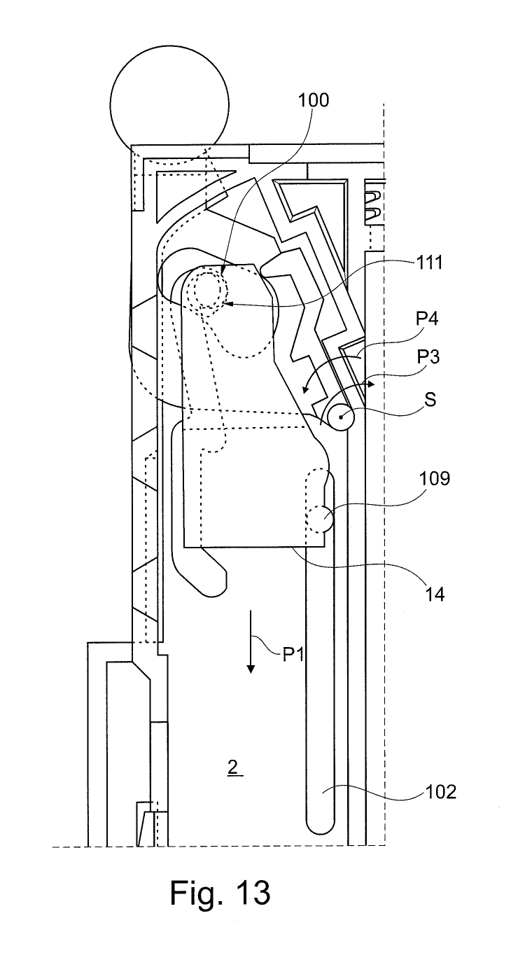

Readjusting of the force accumulator 3 is performed by readjusting the position of the fixed mounting 13 having the mounting part 14, to which the first end of the force accumulator 3 or the first ends of the helical springs 10 and 11 are fastened, respectively. The force accumulator 3 with the helical springs 10, 11 which are releasably hooked into the mounting part 14 is not shown in FIGS. 13 to 22.

During operation of the ejector unit 1, the fixed mounting 13 then remains in the preadjusted position. In the exemplary embodiment of the ejector unit 1 shown, step-wise readjusting is implemented by way of three dissimilar biases or levels of bias, respectively, of the force accumulator 3. According to FIGS. 3 to 8, the force accumulator 3 is adjusted in such a manner that a position according to a step “zero” or “0” is established, in which the force accumulator 3 provides the minimum adjustable bias as compared with two further positions of the force accumulator 3, having stage “1” in which a slightly higher bias prevails than in stage “0”, and stage “2” having a somewhat higher bias than stage “1”, respectively.

Accordingly, the fixed mounting 13 may be readjusted to three specific and mutually dissimilar positions on the base plate 2. Advantageously, the mounting part 14 in each case under the action of the biased helical springs 10, 11 is in all three positions secured against being moved out of the adjusted position. The mounting part 14 herein is under a securing force which here is a tensile force in the direction 91 which is provided by the helical springs 10, 11 which are stretched apart.

In principle, also only one helical spring, or another spring, is possible as a force accumulator, or more than two, in particular, separate springs which are grouped together, or are collectively effective in an identical manner, respectively, are possible in order for the spring pack to be formed.

Readjusting the force accumulator 3 to one of the three positions having stages “0”, “1”, and “2” is performed manually and advantageously without a tool by one hand movement of a person. To this end, the operating portion 16, prior to or following fitting of the ejector unit 1, is gripped, and the set part 15 is pivoted about the pivot axis S in the clockwise direction according to P3, or counter to the clockwise direction according to P4 (cf. FIG. 13). The pivot mounting of the set part 15 is implemented by a mounting peg 118 on the set part 15, which engages in a matching mounting bore 119 on the base plate 2, somewhat above an end of the slotted track 102 that faces away from the force accumulator 3.

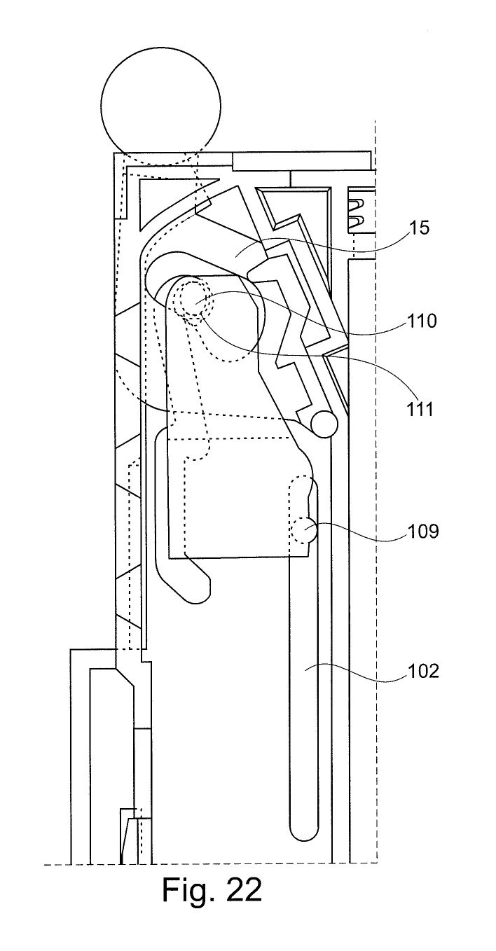

The position of the set part 15 that is pivoted to a maximum about the pivot axis S in the direction P3 and in which the position of the force accumulator 3 provides a maximum bias, corresponding to stage “2”, is shown in FIGS. 13 and 22.

FIG. 17 illustrates the position of the force accumulator 3 at the minimum bias at stage “0”.

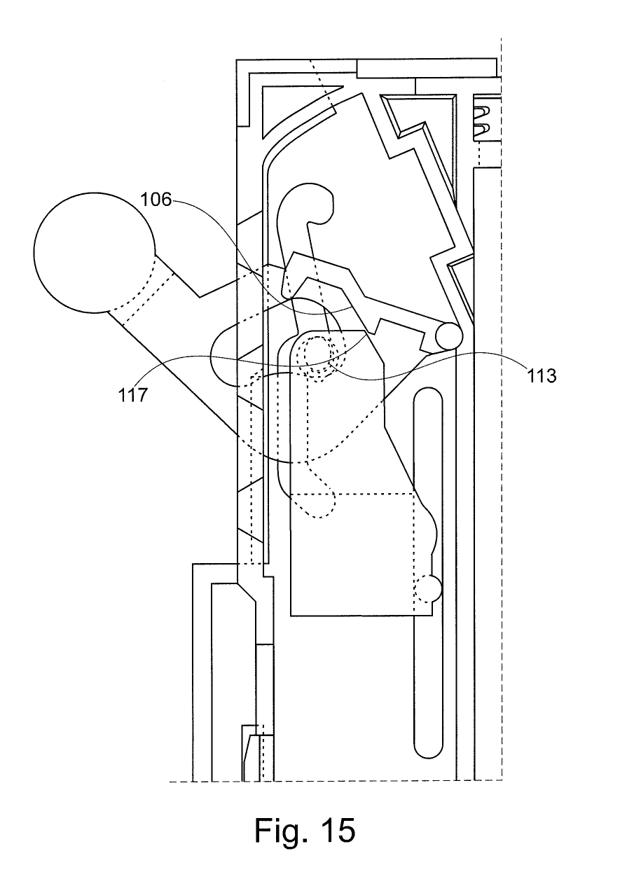

The position of the force accumulator 3 having a medium bias according to stage “1” can be seen in FIGS. 15 and 19.

All other figures illustrate snapshots during the operation or during pivoting of the set part 15, respectively, this being performed at a corresponding effort in force by the person who operates the set part 15.

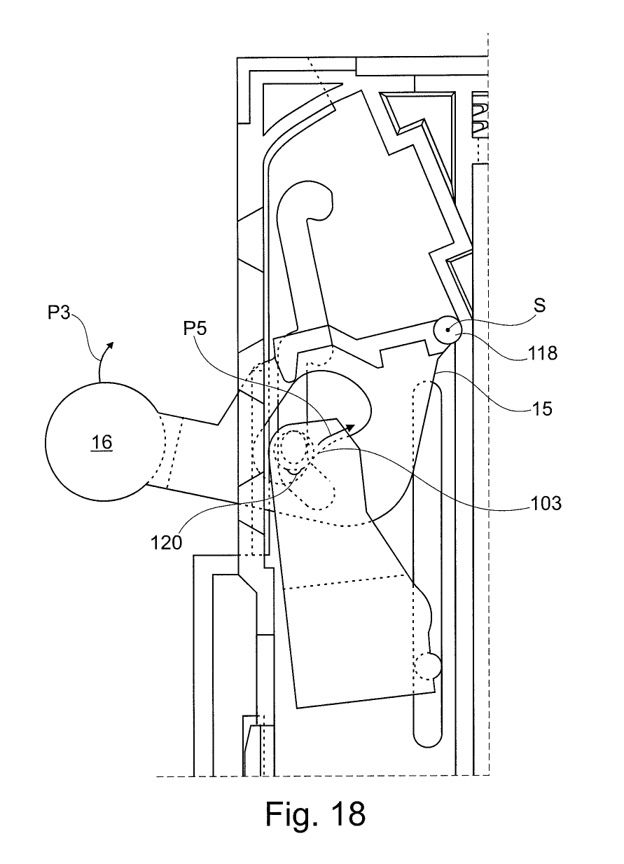

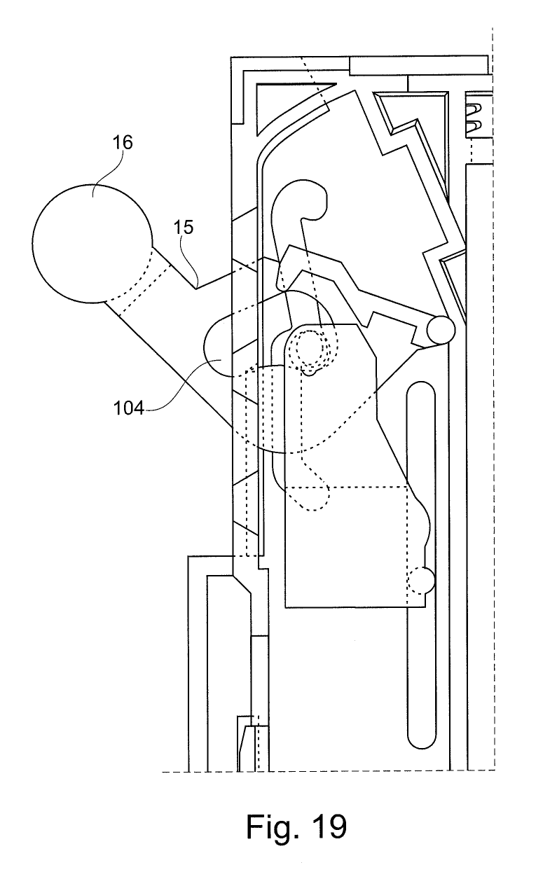

Accordingly, the snapshots according to FIGS. 13 to 17 describe readjusting the force accumulator 3 from stage “2” to stage “0”, by way of which relaxing of the force accumulator 3 is performed. FIGS. 18 to 22 elucidate biasing the force accumulator 3 from stage “0” to stage “2”.

The interaction between the set part 15 and the mounting part 14 and the guide track 101 is fundamental to readjusting the force accumulator 3 in a defined guided manner.

By manually pivoting the set part 15, the mounting part 14 is conjointly moved by the set part 15, wherein the position or movement, respectively, of the mounting part 14 is predefined by the guide track 101 or by the spatial profile of the movement on the base plate 2.

According to the present invention, the adjustment means comprise two separate guide regions which are capable of being mutually offset and which, in particular, are present on separate components. One guide region is positionally fixed, for example, and here is formed by the guide track 101. The further guide region is capable of being repositioned and is located on the set part 15, comprising an opening-periphery portion 103, a guide opening 104 in the set part 15, and guide contours 105 and 106. The opening-periphery portion 103 extends along the concavely curved periphery of the guide opening 104, across the length a (cf. FIG. 11). The first guide contour 105 and the second guide contour 106 both are configured on a front side of a step 107. The step 107 on a planar upper side 108 of the set part 15 projects upwardly in the manner of a pedestal.

The position of an engagement portion on the mounting part 14 that is designed as a pin 100, and thus the position of the mounting part 14, is predefined by the relative position of the two guide regions. In the exemplary embodiment of the present invention illustrated, the predefinition of the engagement portion or of the pin 100, respectively, and thus of the mounting part 14, is determined by way of the guide track 101 and the pivot position of the set part 15.

To this end, the pin 100, which on a side which is directed toward the set part 15 projects from the mounting part 14, engages through the guide opening 104 and in the guide track 101. The potential stationary positions of the pin 100, and thus of the mounting part 14, are determined by the material-free face of the guide opening 104, on the one hand, and by the guide track 101, on the other hand. The length of the pin 100 is greater than a thickness of the set part 15 such that a free end portion of the pin 100 projects so far into the guide track 101 that the pin 100 is securely positioned in the guide track 101.

For optimized readjusting of the mounting part 14, a further pin is configured as the mounting pin 109 which projects from the mounting part 14 and which engages in the linearly extending slotted track 102 and therein is guided in the directions P1 and P2 in a sliding-along motion when the mounting part 14 is being readjusted.

The respective tensioned position of the force accumulator 3 is adjustable by manually pivoting the set part 15, this being explained hereunder with reference to the sequenced positions according to FIGS. 13 to 22.

According to FIG. 13, the biased force accumulator 3 is located in stage “2”, wherein the mounting part 14 under the tensile force of the biased helical springs 10, 11 is impinged in the direction P1 and is trapped in this position. Herein, the pin 100 by way of a forward pin portion 110 which is approximately egg-shaped in the cross section, is pushed into a trough of an upper track portion 111 which is laterally offset on the guide track 101. The track portion 111 forms an end portion of the guide track 101, having like also the track portions 113 and 115 a stop function for the pin 100.

Stage “2” is preadjusted when in the case of ejecting by way of the ejector unit 1, or with the aid of the force accumulator 3, respectively, the mass to be moved lies in an upper employment range, for example, in the case of large or of comparatively wide drawers, respectively, having a high maximum payload.

The guide track 101 comprises the further track portions 112 to 115 (cf. FIG. 10) which adjoin the track portion 111 in a downward manner, or in the direction P1, respectively.

The pin 100, above the pin portion 111, has a pin portion 116 having a cross section which in relation to the external shape of the pin portion 110 is larger and predominantly circular. The pin portion 116 is configured so as to externally interact with the opening-periphery portion 103 of the guide opening 104 in the set part 15.

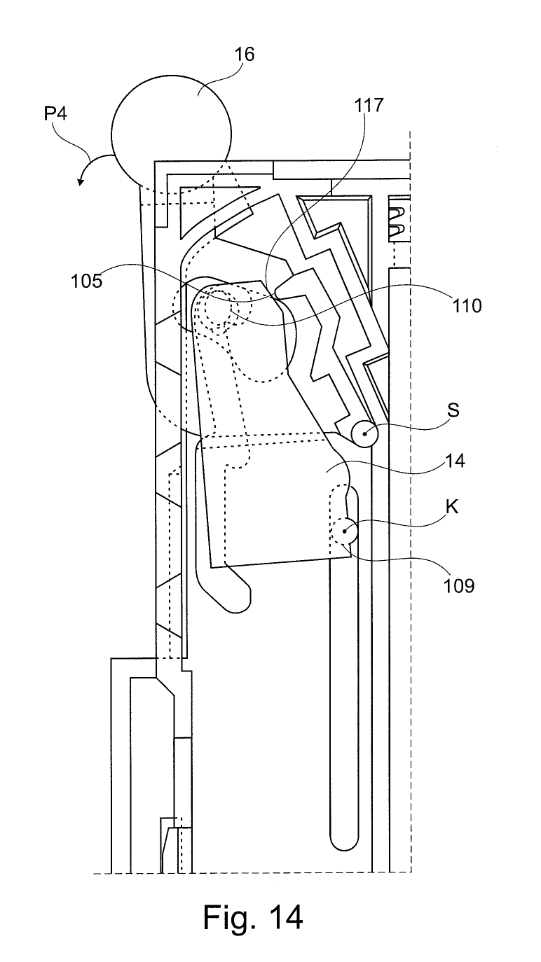

In order for the force accumulator 3 to be readjusted from the maximum biased position according to stage “2” to stage “1” according to FIG. 15, the set part 15 is slightly and manually pivoted in the direction P4 (cf. FIG. 14). Herein, the guide contour 105 which is rounded, for example, presses onto an oblique external flank 117 on the mounting part 14. Herein, the pin portion 110 is pressed against the track portion 111, wherein the mounting part 114 is tilted in a counter-clockwise manner by a few angular degrees about a tilting axis K on the mounting pin 109. Herein, the pin portion 110 is released from the trough of the track portion 111. Subsequently, and without further intervention by the user, and assisted by the tensile force of the helical springs 10, 11, the mounting part 14 automatically slips to the then biased position of the force accumulator 3 according to stage “1”. On the way there, the pin portion 110 slides in the guide track 101 along the track portion 112 which runs in a downwardly inclined manner and so as to be somewhat inclined toward to the slotted track 102. The readjustment procedure to stage “1” of the force accumulator bias is completed once the pin portion 110, again under the acting tensile force of the helical springs 10, 11, is trapped in the trough-type track portion 113. Stage “1” is preadjusted, in particular, when in the case of ejecting by way of the ejector unit 1, or with the aid of the force accumulator 3, respectively, the mass to be moved lies in a medium employment range.

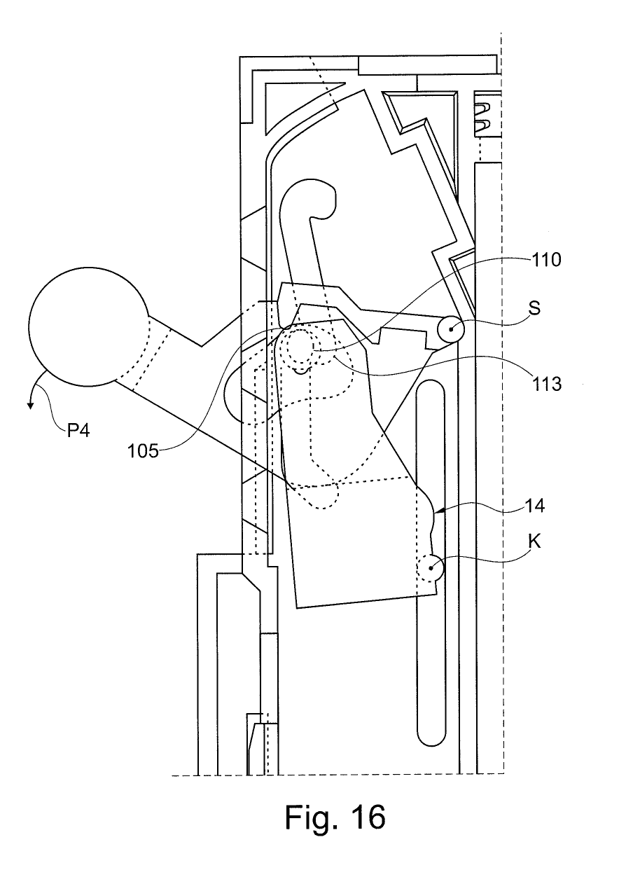

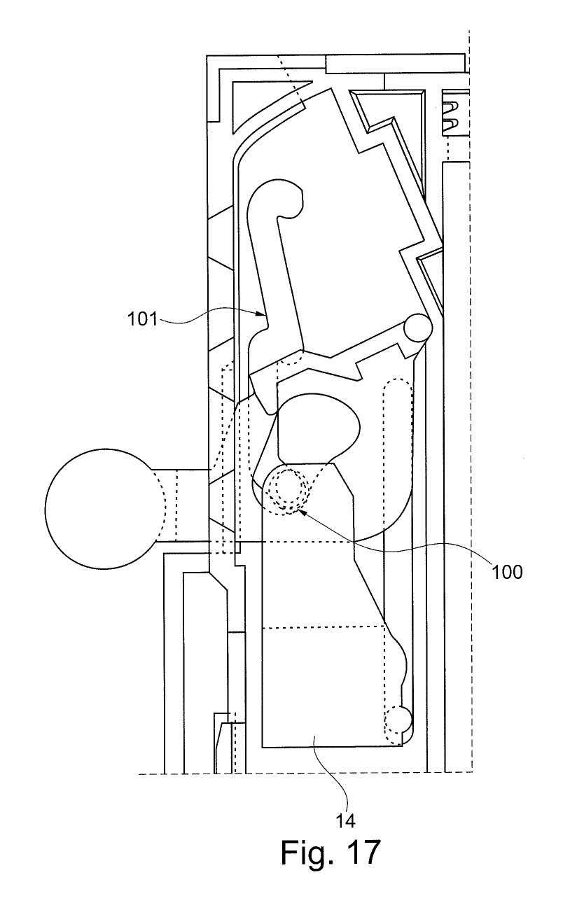

For readjusting from stage “1” to stage “0” according to FIG. 17, the user also has only to reposition the set part 15 by a few angular degrees in the direction P4 about the pivot axis S, wherein the pin portion 110 with the aid of the flank 105 which presses against the mounting part 14 is moved out of the trough of the track portion 113, this being elucidated in FIG. 16. As is the case when being released from stage “2”, the mounting part 14 also herein tilts somewhat about the tilting axis K on the mounting pin 109. To this end, a slight or brief effort in force, respectively, counter to the action of the biased helical springs 10, 11 is required by way of action on the set part 15. Pushing away, or repositioning the mounting part 14, respectively, by pivoting the set part 15 is performed by means of contact between the oblique guide contour 106 on the step 107, and the oblique external flank 117 on the mounting part 14 (cf. FIG. 15). Once the mounting part 14 has been moved out of the trough of the track portion 113, the mounting part 14 under the tensile action of the helical springs 10 and 11 is subjected to a readjustment movement in the direction P1, wherein the pin portion 110 along the straight track portion 114 automatically enters the laterally bent end region of the guide track 101, or enters the track portion 115, respectively, bearing thereon (cf. FIG. 17). Stage “0” of the force-accumulator bias is preadjusted thereby and is selected when in the case of ejecting by way the ejector unit 1, or with the aid of the force accumulator 3, respectively, the mass to be moved lies in a lower employment range.

The pin portion 110 in the respective stages “2”, “1”, and “0” by way of tensile forces is pressed into the respective associated trough of the guide track 101, wherein an external side of the pin portion 110 in a planar manner lies tight against the walls of the trough-shaped track portions 111, 113, and 115.

The snapshots according to FIGS. 18 to 22 elucidate tensioning of the force accumulator 3 from the force-accumulator bias of stage “0” to stage “1” and further to stage “2”, which is likewise performed by manually pivoting the set part 15 in the direction P3 about the pivot axis S. Herein, interaction between the set part 15 and the mounting part 14 arises by way of the contact between the opening-periphery portion 103 and the pin portion 116. Herein it is preferable for a convex elevation 120 to outwardly project from a predefined point of the otherwise circular external shape of the pin portion 116, which elevation temporarily comes to bear on the opening-periphery portion 103.

Proceeding from stage “0” according to FIG. 17, a force has to be applied for tensioning the force accumulator 3 in the course of manually pivoting the set part 15 in the direction P3 until stage “1” according to FIG. 19, in which the mounting part 14 with the aid of the tensile force of the helical springs 10, 11 acting on the mounting part 14 is held in a self-securing manner in this positioning is reached. When readjusting from stage “0” to stage “1”, a contact point between the pin portion 116 and the respective spot of the opening-periphery portion 103 moves in the direction P5 (cf. FIG. 18), or in the direction toward the mounting pin 118, respectively.

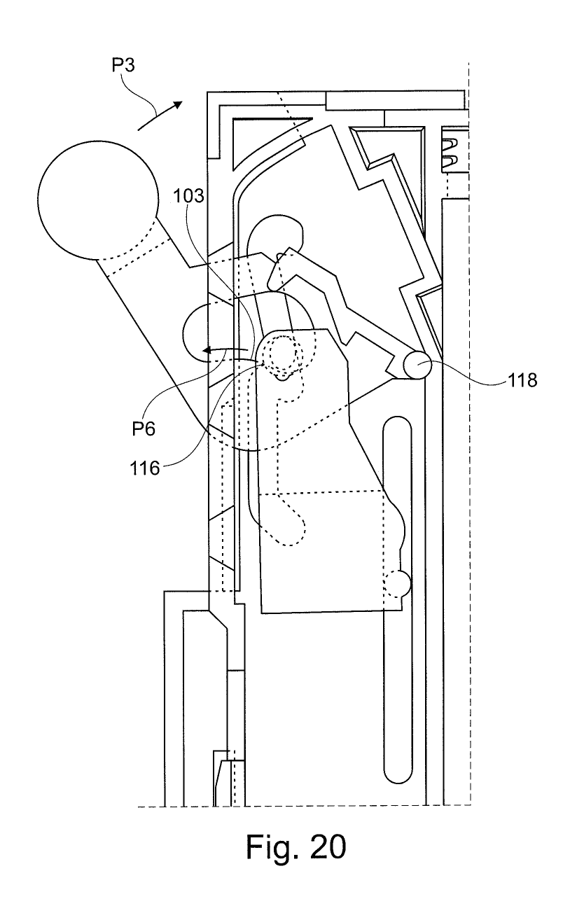

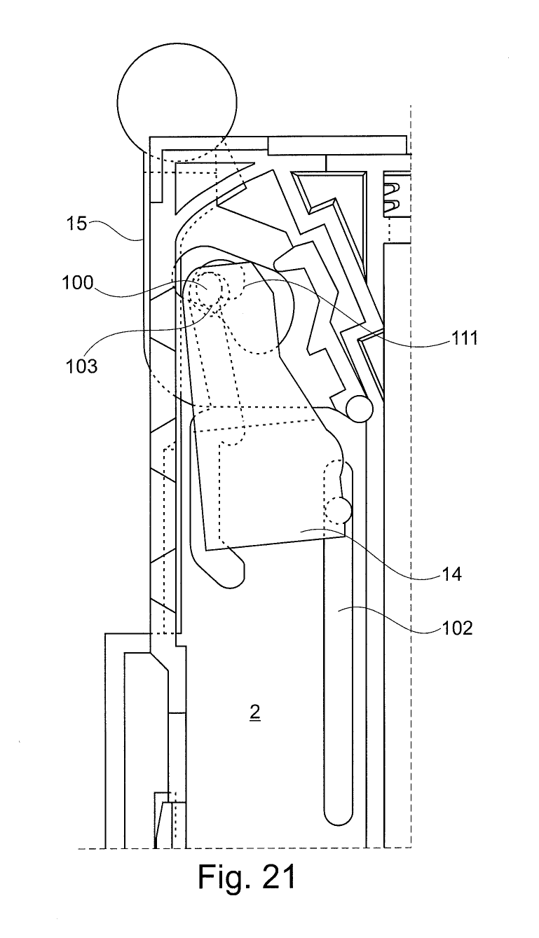

When readjusting the bias of the force accumulator 3 from stage “1” to stage “2”, the set part 15 must be pivoted farther in the direction P3, or must be manually pushed upward on the operating portion 16, respectively, wherein the pin portion 110 is pushed away by the opening-periphery portion 103 and is moved out of the trough-shaped depression of the track portion 113. When readjusting from stage “1” to stage “2”, a contact point between the pin portion 116 and the respective spot of the opening-periphery portion 103 moves in the direction P6 (cf. FIG. 20), or counter to P5, or in the direction away from the mounting pin 118, respectively. The external tensioning force is required for so long until stage “2” according to FIG. 22, in which the mounting part 14 with the aid of the tensile force of the helical springs 10, 11 acting on the mounting part 14 is held in a self-securing manner in this positioning is reached. The pin portion 110 is trapped in the trough of the track portion 111. Decreasing the bias of the force accumulator 3 from stage “2” to stage “1” or “0” may then be performed as has been explained above in the context of FIGS. 13 to 17.

The mounting part 14 in all positions thereof is not only guided in the guide track 101 on the base plate 2 by way of the pin 100, but also in the slotted track 102 by way of the mounting pin 109.

### LIST OF REFERENCE SIGNS

1 Ejector unit
2 Base plate
3 Force accumulator
4 Coupling installation
5 Ejector
6 Activator
7 Locking member
8 Front-gap adjustment assembly
9 Cover component
10 Helical spring
11 Helical spring
12 End
13 Fixed mounting
14 Mounting part
15 Set part
16 Operating portion
17 End
18 Motion element
19 Guide contour
20 Linear guide
21 Contact portion
22 Set screw
23 Entrainment element
24 Latch component
24a Guide pin
25 Guide track
26 Stop element
27 Guide track
30 Tension lever
21 Mounting pin
32 Retaining member
33 Spring element
34 Guide lever
35 Connection element
36 Mounting pin
37 Mounting pin
38 Mounting pin
39 Mounting pin
40 Lever attachment
41 Locking element
42 Stop element
43 Flap
44 Contact portion
45 Housing
46 Operating portion
47 Wall portion
48 Wall
49 Leaf spring
50 Item of furniture
51 Basic furniture structure
52 Guide means
53 Drawer
54 Drawer base
55 Drawer front
56 Side wall
55 Rear drawer wall
58 Device
59 Basic structure side wall
60 Leg spring
61 Synchronizer bar
62 Device
63 Linear guide
100 Pin
101 Guide track
102 Slotted track
103 Opening-periphery portion
104 Guide opening
105 Guide contour
106 Guide contour
107 Step
108 Upper side
109 Mounting pin
110 Pin portion
111-115 Track portion
116 Pin portion
117 External flank
118 Mounting peg
119 Mounting bore
120 Elevation

1. A device for moving a movable furniture part in an opening direction of the furniture part in relation to a basic furniture structure of an item of furniture, wherein the movable furniture part by way of guide means is capable of being put in the opening direction and in a closing direction which is counter to the opening direction, wherein the device comprises a force accumulator which is received on a mounting part such that by way of the fitted device the movable furniture part under action of the force accumulator is capable of being put in the opening direction of the movable furniture part, and wherein adjustment means for readjusting the force accumulator are present, characterized in that the adjustment means comprise two mutually separate guide regions which are adapted for guiding an engagement portion on the mounting part, wherein the guide regions are capable of being mutually offset so as to predefine a region in which the engagement portion is received and positioned, wherein the position of the engagement portion is determined by the interaction between the two guide regions such that the position of the engagement portion on the device depends on the mutual relative position of the two guide regions.

2. The device according to claim 1, wherein the two guide regions partially overlap in a mutually adjacent manner and establish an overlap region in which the engagement portion is received and positioned.

3. The device according to claim 1, wherein a guide region is positionally fixed.

4. The device according to claim 1, wherein precisely one guide region is movable.

5. The device according to claim 1, wherein the guide region comprises a guide contour.

6. The device according to claim 1, wherein a guide region is configured on a set part which is present so as to be movable on the device, in particular on a pivot part which is present so as to be pivotable on the device.

7. The device according to claim 1, wherein the guide regions are mutually adapted in such a manner so as to undertake readjusting of the mounting part in multiple steps.

8. The device according to claim 1, wherein a guide region which comprises separate contact portions for contacting the engagement portion on the mounting part is present on a movably mounted component.

9. The device according to claim 1, wherein a guide region is present on a movably mounted component, wherein a first contact portion for contacting the engagement portion on the mounting part is configured for increasing a bias of the force accumulator, and a second contact portion for contacting the engagement portion on the mounting part is configured for decreasing the bias of the force accumulator.

10. The device according to claim 1, wherein the mounting part on the device by way of the engagement portion is readjustable in a guided manner, wherein the mounting part is guided on the device by way of an auxiliary guide having an auxiliary engagement portion.

11. The device according to claim 1, wherein the adjustment means are adapted in such a manner that a self-securing readjustment position of the mounting part is established on the device under the action of the force accumulator.

12. An item of furniture having a basic furniture structure on which a furniture part by way of guide means for a guided movement is movable in an opening direction and in a closing direction which is counter to the opening direction, wherein a device according to claim 1 is present.
